(19) United States
(12) Patent Application Publication
(10) Pub. No.: US 2026/0022542 A1
(43) Pub. Date: Jan. 22, 2026

(54) SYSTEM FOR EXTRACTING WATER FROM THE ATMOSPHERE

(71) Applicant: Aleksei Pikhtovnikov, Fillmore, CA (US)

(72) Inventor: Aleksei Pikhtovnikov, Fillmore, CA (US)

(21) Appl. No.: 19/272,233

(22) Filed: Jul. 17, 2025

Related U.S. Application Data
(60) Provisional application No. 63/673,082, filed on Jul. 18, 2024.

(51) Int. Cl. E03B 3/28; B01D 5/00; F25B 13/00

(52) U.S. Cl. CPC E03B 3/28; B01D 5/0003; F25B 13/00

(57) ABSTRACT

A system is disclosed for collecting water from the atmosphere. The disclosed system provides two fluidly coupled dual-purpose heat exchangers enabling a reversible refrigeration cycle, wherein while a first dual-purpose heat exchanger deposits atmospheric moisture on an associated sub-freezing surface, a second dual-purpose heat exchanger is heating its associated surface to above-freezing temperatures to melt earlier deposited frost or ice on its associated above-freezing surface. The cooling conditions and the heating conditions of each dual-purpose heat exchanger can be selectively toggled so that as the first dual-purpose heat exchanger is depositing solid water of its associated surface the second dual-purpose heat exchanger is melting its previously deposited solid water from its associated surface. The systems configurations enable the reversing of the refrigerant cycle so that the depositing and melting process are effectively undertaken.

### CROSS REFERENCE TO RELATED APPLICATION

This application claims the benefit of priority of U.S. provisional application No. 63/673,082, filed Jul. 18, 2024, the contents of which are herein incorporated by reference.

### BACKGROUND OF THE SUBJECT DISCLOSURE

The present subject disclosure relates to water collection from atmospheric moisture and, more particularly, to a system for extracting water from the atmosphere via two fluidly coupled dual-purpose heat exchangers enabling a reversible refrigeration cycle, wherein while a first dual-purpose heat exchanger deposits atmospheric moisture on an associated sub-freezing surface, a second dual-purpose heat exchanger is heating its associated surface to above-freezing temperatures to melt its earlier deposited frost or ice.

At present, many regions of the Earth are experiencing a shortage of drinking water, or its acquisition is associated with serious difficulties or is expensive. In many places, it is impossible to construct infrastructure for water delivery to homes, businesses, or for agriculture. Water is always present in the atmosphere, even under the hottest and driest condition; however, existing solutions for obtaining water from air based on condensation are bulky, inefficient, slow, and require, in some contexts, a prohibitive amount of energy to implement.

Existing methods of desalinating ocean water can only operate on ocean shores. Existing methods of atmospheric water generation based on condensation are inefficient due to the low rate/speed of water condensation from the air's gaseous phase to the liquid phase, in comparison to the rate of water collection enabled through deposition, where water vapor changes directly to ice without first becoming a liquid.

As can be seen, there is a need for a system for extracting water from the atmosphere via two fluidly coupled dual-purpose heat exchangers enabling a reversible refrigeration cycle, wherein while a first dual-purpose heat exchanger deposits atmospheric moisture on an associated sub-freezing surface, a second dual-purpose heat exchanger is heating its associated surface to above-freezing temperatures to melt its earlier deposited frost or ice.

### SUMMARY OF THE SUBJECT DISCLOSURE

The subject disclosure is used for extracting water from air via deposition, where atmospheric water vapor accumulates, in the form of frost and ice, on sub-freezing surfaces.

The subject disclosure enables the extraction of this atmospheric water in quantities necessary for agricultural needs, domestic uses, or industrial purposes. This is achieved by quick deposition on and then quickly melted off a surface associated with a dual-purpose heat exchanger. The dual-purpose heat exchanger embodies selectively controllable heating properties and cooling properties. The associated surface of the dual-purpose heat exchanger can thus be selectively cooled below 0-degrees Celsius and subsequently warmed above 0-degrees Celsius whereby atmospheric or ambient moisture accumulates as deposited frost or ice on the associated surface, which when heated by the heating properties of the dual-purpose heat exchanger melts in collectable water.

The subject disclosure embodies a system of two dual-purpose heat exchanger fluidly coupled in series or another manner so that as a first dual-purpose heat exchanger is utilizing its heating properties (to melt deposited frost and ice) the second dual-purpose heat exchanger is utilizing its cooling properties to deposit water vapor (in the solid phase of frost and ice) on their respective associated surface, respectively. Thereby, the subject disclosure system enables utilizes a refrigerant cycle that is, in effect, “reversable”, where the heating and cooling properties of the fluidly coupled dual-purpose heat exchanger can be selectively toggled so that one refrigerant efficiently facilitates the heat exchange happening nearly simultaneously in both dual-purpose heat exchangers.

The efficiencies of both the rate water collection from deposition as opposed to water collection from condensation) as well as the physical efficiencies of two reversible dual-purpose heat exchangers allows the subject disclosure to be used for agricultural purposes, housing water supply, and in locations where obtaining water is too expensive or impossible.

The subject disclosure deposits atmospheric water vapor on sub-freezing surfaces in the form of frost or ice, which in turn can be collected as water through heating the same surface, thereby efficiently and expeditiously facilitating the water production process compared to prior art systems found on condensation of water in its liquid phase. The systemic sub-freezing and above-freezing temperatures for the same surface are enabled via dual-purpose heat exchangers that each include a “condenser” and “evaporator”.

The system embodied by subject disclosure leverages the phase-reversing nature to extract water from the air. The effectuated phase changes/reversals are enabled by reversing the direction of the refrigerant cycle between two fluidly coupled dual-purpose heat exchanger, thereby selectively toggling between condenser mode and evaporator mode at the first dual-purpose heat exchanger while the second dual-purpose heat exchanger cyclically toggles between the inversion condition of the first dual-purpose heat exchanger, thereby efficiently the refrigerant through reversible sequential thermodynamic heat pump cycles and refrigeration cycles at each node/dual-purpose heat exchanger.

The two fluidly coupled dual-purpose heat exchanger are components within systemic “sealed loops” that include fluid lines, compressors, and metering devices, wherein each sealed loop maintains its own compressor and mechanically combined within two heat exchangers. In this process, the condenser mode (“phase”, or “component”) of the dual-purpose heat exchanger, by heating up, melts the frost accumulated in the immediately previous cooling condition when the dual-purpose heat exchanger was functioning as in the evaporator mode. During operation, the compressor compresses the gaseous refrigerant, which, upon cooling in the condenser, turns into a liquid that is then fed through the metering device/unit to the evaporator. There, the refrigerant evaporates, cooling the evaporator, on which water, previously from the atmospheric air deposits as frost or ice.

The refrigerant cycle's direction (the flow of the coolant/refrigerant) between the two fluidly coupled dual-purpose heat exchangers is changed (or “reversed”) upon reaching specific parameters and/or depending on external conditions, or after a certain period. For example, using sensors and a controller to optimize cycle reversal based on environmental conditions, or through timers, systemic cycle reversion can be automated.

The collected water is then stored in a tank or sent directly to consumers for further use. Depending on the defined switching conditions, the process is repeated multiple times. The system can be powered either from a mains source or from renewable energy sources.

The ability of the subject disclosure to be used anywhere on Earth makes it unique and allows it to address water supply problems universally. The deposition process on a surface cooled below freezing is significantly more effective than other methods, such as condensation.

Devices embodying the subject disclosure are scalable and so can either be a small device that can, say, supply water locally to a small consumer, such as a tree in a garden, powered by a small solar panel, or can be a large device capable of supplying water up to an entire city.

The subject disclosure embodies a system for extracting water from the atmosphere by depositing solid water on sub-freezing surfaces during a cooling condition that reverses to melt accumulated frost from the same surface. The system enables deposition at sub-zero temperatures and even faster water collection rates through a reversible refrigerant cycle where the condenser and evaporator for each dual-purpose heat exchanger swap roles to melt frost, using configurations like two-position valves, three-way valves, or “dual arrangements”.

Unlike typical atmospheric water generators that condense above 0° C., the subject disclosure uses sub-zero frost formation and refrigerant cycle reversal for efficiency. The combination of frost-based deposition and reversible refrigerant cycles fluidly coupled between two systemic dual-purpose heat exchangers is not a straightforward or obvious adaptation of existing systems. And so, the subject disclosure inventively provides water in scarce regions, with practical applications across scales.

The subject disclosure uses two dual-purpose heating exchangers in a refrigeration system that is configured so that when one is cooling, another is heating-then they swap, thereby affording efficient atmospheric water collection. Simply put, the subject disclosure enables fast water collection through freezing, and fast melting due to work in two dual-purpose heating exchangers fluidly coupled by a reversible refrigerant cycle.

In one aspect of the present subject disclosure, a system for converting water vapor to liquid water includes a first dual-purpose heat exchanger and a second dual-purpose heat exchanger arranged in a fluid coupling in such a way as to enable a reversible refrigeration cycle of the first and second dual-purpose heat exchangers so that while the first dual-purpose heat exchanger, in a cooling condition, cools a first surface associated thereto, the second dual-purpose heat exchanger, in a heating condition, heats a second surface associated thereto.

In another aspect of the present subject disclosure, the system for converting water vapor to liquid water further includes where, in operation, a first ambient water vapor deposits frozen water on the first surface when the first surface reaches a sub-freezing temperature while deposited frozen water on the second surface melts for collection after the second surface reaches an above-freezing temperature, wherein a controller is operatively associated with the system so that the reversible refrigeration cycle is selectively activated, whereby when the first dual-purpose heat exchanger switches from the cooling condition to the heating condition, the second dual-purpose heat exchanger switches from the heating condition to the cooling condition, wherein the reversible refrigeration cycle is enabled by a refrigerant coursing through the fluid coupling, wherein each dual-purpose heat exchanger provides an evaporator component and a condenser component for changing a temperature of their respective associated surface, wherein a compressor is operatively associated with the system for pressurizing the refrigerant into a gaseous state for entering the condenser of the first or second dual-purpose heat exchanger that is in the respective heating condition, wherein a metering device is operatively associated with the system for dropping the pressurize of the refrigerant leaving the condenser of the first or second dual-purpose heat exchanger in the respective heating condition, wherein the metering device liquifies said refrigerant for entering the evaporator of the first or second dual-purpose heat exchangers in the respective cooling condition, wherein valves are operatively associated with the fluid coupling to effectuate the reversible refrigeration cycle, wherein the controller is programmable to activate the reversible refrigeration cycle when one or more predetermined thresholds are met, and wherein one or more sensors are operatively associated with the system determining when the one or more predetermined thresholds are met.

These and other features, aspects and advantages of the present subject disclosure will become better understood with reference to the following drawings, description and claims.

### BRIEF DESCRIPTION OF THE DRAWINGS

FIG. 1 is a schematic view of an exemplary embodiment of the subject disclosure.

FIG. 2 is a schematic view of an exemplary embodiment of the subject disclosure.

FIG. 3 is a schematic view of an exemplary embodiment of the subject disclosure.

FIG. 4 is a schematic view of an exemplary embodiment of the subject disclosure.

FIG. 5 is a schematic view of an exemplary embodiment of the subject disclosure.

FIG. 6 is a schematic view of an exemplary embodiment of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the subject disclosure provides the following systemic components:
10 Compressor
12 High Pressure Line Valve
13 Stop Valve
14 Low Pressure Line Valve
16 Controller
18 Condenser/Evaporation Component
19 Combined Condenser/Evaporation Component
20 Sensors
22 Metering Component
24 Power Supply Component
26 Fan
28 Water Tank
30 Reversive Valve
32 Two-Directional Compressor
34 Refrigerant Pathway
36 Management Connection
38 Sensor Connection

In operation, compressor 10 or compressor 32—depending on to systemic loop or configuration—pressurizes a coolant/refrigerant in its gaseous state, thereby increasing the temperature of the gas.

The controller and a distribution device may serve each other in different cycles and be mechanically combined with each other. There may be two units of a controller and distribution device in combined units.

In cycle, the first dual-purpose heat exchanger of the two fluidly coupled dual-purpose heat exchangers may use an evaporator to cool an operatively associated surface to or below the freezing point of water, thereby forming ice and frost on the associated surface (not shown).

After collecting sufficient frost and/or ice, as determined by one or more sensors, the system switches the refrigerant cycle/coolant direction, whereby the first dual-purpose heat exchanger acts as a condenser and starts producing heat-melting the frost to water, while the second fluidly coupled dual-purpose heat exchanger of the two coupled dual-purpose heat exchanger acts as an evaporator and starts producing frost on an operatively associated surface. During the next cycle a reverse of the refrigerant cycle is effectuated. There are several possible combinations with different valve types or two compressors.

Refrigerant is responsible for the movement of heat by absorbing or rejecting heat, thereby effectuating heating condition and cooling conditions, respectively.

The refrigerant cycle is the process of the refrigerant moving round the thermodynamic system, and involves four main components compressor, condenser, metering device, and evaporator. The flow or direction of refrigerant is selectively controllable in the subject disclosure to proceed as following compressor→discharge line→condenser→liquid line→metering device→expansion line→evaporator→suction line→ and then back to the compressor, or vice versa in the reverse mode when a systemic dual-purpose heat exchanger is to be in the heating condition, where the refrigerant circles the other way around in the system—i.e., the condenser of the first dual-purpose heat exchanger becomes the evaporator and the evaporator becomes the condenser in the second dual-purpose heat exchanger.

The compressor selectively moves the refrigerant around the refrigerant cycle. The compressor creates a pressure differential, resulting in high pressure on the high side (discharge line, condenser, and liquid line) and low pressure on the low side (suction line, evaporator, and expansion line).

Condensers reject heat from the refrigerant changing its state from vapor into liquid to de-superheat the refrigerant (reduce the temperature to the condensing temperature), condense (saturate) the refrigerant (reject heat until all the refrigerant turns to liquid), and to sub-cool the refrigerant (reduce the temperature of the refrigerant below the condensing/saturation temperature). The condenser's important job is to reduce the temperature of the refrigerant to its condensing (saturation) temperature, then to further reject heat until the refrigerant fully turns to liquid so it can boil in the evaporator.

The hot vapor from the compressor enters the condenser, and the superheat (temperature above condensing temperature) is then removed at which point the refrigerant begins to change state from vapor to liquid (condensing). The temperature of the liquid may then fall again, known as sub-cooling.

The metering device creates a pressure drop to facilitate refrigerant boiling in the evaporator coil. There are different types of metering devices such as thermostatic expansion valves (TEVs) or electronic expansion valves (EEVs). The metering device may be located between the liquid-line and the evaporator, where the liquid-line is full of high-pressure liquid refrigerant. When the high-pressure liquid reaches the small piston in the metering device, the pressure reduces to such a degree that the saturation temperature is lower than the temperature of the air surrounding the refrigerant tubing. At this point, the refrigerant starts to change from liquid to vapor.

The process of the evaporator may start as soon as the refrigerant leaves the metering device and continues until the refrigerant has absorbed enough heat to complete the transition.

The compressor 10 creates pressure in the gaseous coolant within the discharge line, directing it through a first high-pressure line valve 12 of the first unit and a second high-pressure line valve 12 of the second unit. From the first high-pressure line valve 12, the coolant enters a first condenser-evaporator component 18 where it releases heat into the environment. The cooled coolant condenses and passes as a liquid through the metering component 22 to a second condenser-evaporator component 18 of the second unit, where it evaporates into a low-pressure gas, absorbing heat from the environment. This process causes atmospheric moisture to deposit on the associated surfaces (not shown) of the dual-purpose heat exchanger, transforming into water. The low-pressure gas then flows to valves of the second high-pressure line valve 12 of the second unit and a second low pressure line valve 14 of the second unit. From the second low pressure line valve 14, the coolant returns to the compressor, and the cycle repeats. Upon triggering conditions, the controller 16 stops the compressor 10 and switches the valve positions to initiate the reverse cycle. When cycle one reaches the desired temperature, as determined by at least one sensor 20 enabled by a sensor connection 38, the refiguration cycle reverses for a predetermined time, established by a timer module.

The improved cooling system based on the ‘reversible’ (through switching elements—e.g., reversible valves—along the fluid couplings) circulation of the coolant of the refrigerant cycle within a sealed loop embodies several principal components: the compressor 10 or 32 adapted for compressing gaseous coolant, which may be any refrigerant substance circulating within the system, which either emits or absorbs heat, thereby enabling the system's functionality.

Condenser-evaporator components (dual-purpose heat exchanger 18) cools the compressed coolant by releasing heat into the environment, and when the flow direction of the coolant changes, it becomes an evaporator. Metering unit 22 separates the condenser component and the evaporator component, through which the coolant transitions to a liquid phase. The evaporator component, into which liquid coolant is injected and where it evaporates, absorbs heat and thereby cools the surrounding environment. When the flow direction of the coolant changes, it becomes a condenser component.

Sensors 20 provides information on the state of the surrounding environment, based on which control decisions may be made. Controller 16 takes control decisions and facilitates the startup of the system, the change of system modes, control of system parameters and environmental conditions, system stoppage, or any other change of the system state as per predefined conditions. An operatively associated valve system facilitates the change in the direction of the coolant flow/refrigerant cycle.

Power source 24 may be any source of electrical or mechanical energy to power system components. A storage component 28 (e.g., water tank) for collecting and storing water produced by the system may be operatively associated with the relevant systemic components, even though that is not shown in detail in the Figures. A distribution device for distributing the collected or produced water may be provided. Forced air circulation devices 26 that create an air flow through the evaporator to enhance system performance may be provided. Filtering devices that filter the water may also be employed.

During the cooling of the evaporator component of the dual-purpose heat exchanger 18, it cools to a temperature below zero degrees Celsius. This creates conditions under which the water vapor dissolved in the air deposits on the evaporator component and transforms into solid-phase water (ice, frost, rime, and other solid forms of water). In some embodiments, the water vapor condenses to liquid prior to freezing as frost or ice on the associated surface, especially in the initial starting cycle of a sealed loop.

Upon achieving the parameters defined by the set of sensors and/or a timer, the controller changes the direction of the coolant flow through the valve system or the compressor component, thereby reversing the functions of the condenser component and the evaporator: the condenser becomes the evaporator and starts to cool down, collecting atmospheric water, and the evaporator becomes the condenser. The heating of the condenser component leads to the rapid melting of the previously formed solid-phase water. The resultant water may accumulate in storage unit 28 for further use or is distributed to consumers through the distribution device. During operation, devices for forced air supply may be used on the evaporator to increase system performance. Additionally, the air flow may be regulated naturally or by the operation of system components, such as air flow regulators 26, to selectively control access to atmospheric or ambient moisture. Filtering devices may be applied on the water to improve its properties.

The foundation of the subject disclosure lies in the fact that the unit associated with the collection surface embodies the evaporator component that can also ‘dual-purposely’ perform the function of the condenser component, and the condenser can perform the function of the evaporator component, with these devices switching roles upon the change in the direction of the coolant flow.

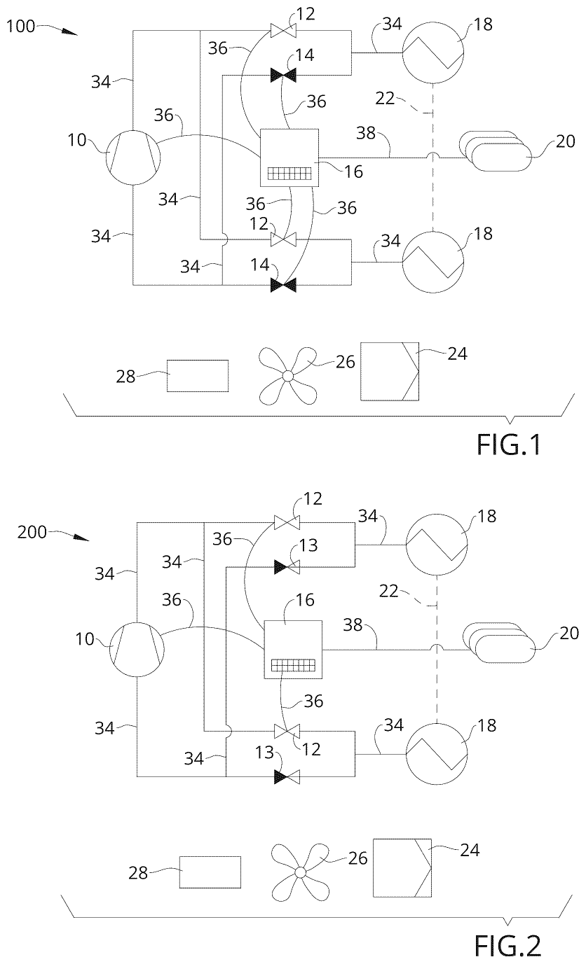

Referring to FIG. 1, the system of the subject disclosure may be based on two-position valves may include a compressor 10 configured to pressurize a gaseous coolant within a discharge line. Condenser/evaporator units wherein each unit functions as either a condenser or an evaporator depending on the direction of the cycle. High pressure valves being two-position valves positioned within the discharge line for controlling the flow of the pressurized coolant. Low pressure valves being two-position valves situated within a suction line to regulate the flow of coolant. An operational sensor set may include environmental sensors based on whose readings a decision to change the direction of the cycle can be made. Metering device 22 may be disposed between the discharge and suction lines, for reducing the pressure of the coolant between these lines. Controller 16 configured to decide the direction of the cycle based on sensor readings and/or timer inputs, and to control the operation of the compressor, the position of the valves, and peripheral service devices.

An optional fan 26 for directing air over the evaporator component may be provided. Power supply 24 for providing energy to the system, with options for using renewable energy sources or electric grid power is provided. Water tank 28 and a distribution device for storing and distributing collected water for use may be provided

Direct cycle operations: the first condenser/evaporator units (CEU1) (also known as the first dual-purpose heat exchanger 18) function as a condenser, and CEU2 18 as an evaporator. Valve positions are as follows: High-pressure line valve for the first unit (HPV1) 12 is open; HPV2 12 is closed; Low-pressure line valve 14 for the first unit (LPV1) is closed; and LPV2 14 is open.

The compressor 10 creates pressure in the gaseous coolant within the discharge line, directing it through HPV1 12 and HPV2 12. From HPV1 12, the coolant enters CEU1 18 where it releases heat into the environment. The cooled coolant condenses and passes through the metering component 22 to CEU2 18, where it evaporates into low-pressure gas, absorbing heat from the environment. This process causes atmospheric moisture to deposit on the external surfaces of the evaporator, transforming into water. The low-pressure gas then flows to valves HPV2 12 and LPV2 14. From LPV2, the coolant returns to the compressor 10, and the cycle repeats.

Upon triggering conditions, the controller 16 stops the compressor and switches the valve positions to initiate the reverse refrigerant cycle.

Reverse refrigerant cycle operations: CEU1 18 functions as an evaporator and CEU2 18 as a condenser. Valve positions are as follows: HPV1 12 is closed; HPV2 12 is open; LPV1 14 is open; and LPV2 14 is closed.

The compressor 10 pressurizes the gaseous coolant in the discharge line, directing it through valves HPV1 12 and HPV2 12. From HPV2 12, the coolant enters CEU2 12 where it releases heat into the environment. The cooled coolant condenses and passes through the metering component 22 to CEU1 18, where it evaporates into a low-pressure gas, absorbing heat from the environment. This process leads to the deposition of atmospheric moisture on the external surfaces of the evaporator, transforming into water. The low-pressure gas then flows to valves HPV1 12 and LPV1 14. From LPV1 14, the coolant returns to the compressor, and the cycle repeats. Upon triggering conditions, the controller stops the compressor and changes the valve positions to revert to the direct cycle.

Referring to FIG. 2, a system based on two-position valves and stop valves is shown having the following components: compressor configured to pressurize a gaseous coolant within a discharge line. Condenser/Evaporator Units (CEU1, CEU2), wherein each unit functions as either a condenser or an evaporator depending on the direction of the cycle. High Pressure Valves (HPV1, HPV2), being two-position valves positioned within the discharge line for controlling the flow of the pressurized coolant. Stop Valves (SV1, SV2), which open under low pipeline pressure and close under high pressure.

Operational Sensor Set (OSS) 38 having environmental sensors 20 based on whose readings a decision to change the direction of the cycle can be made.

Metering component 22 may be disposed between the discharge and suction lines, for reducing the pressure of the coolant between these lines. Controller 16 configured to decide the direction of the refrigerant cycle based on sensor readings and/or timer inputs, and to control the operation of the compressor, the position of the valves, and peripheral service devices.

An optional fan for directing air over the evaporator. Power supply 24 for providing energy to the system, with options for using renewable energy sources or electric grid power. Water Tank and a distribution device for storing and distributing collected water for use.

Direct cycle operations: CEU1 functions as a condenser, and CEU2 as an evaporator. Valve positions are as follows: HPV1 is open; HPV2 is closed; SV1 is closed due to high pipeline pressure; and SV2 is open due to low pipeline pressure.

The compressor creates pressure in the gaseous coolant within the discharge line, directing it through HPV1 and HPV2. From HPV1, the coolant enters CEU1, releasing heat into the environment. The cooled coolant condenses and passes through the metering component 22 to CEU2, where it evaporates into a low-pressure gas, absorbing heat from the environment. This process causes atmospheric moisture to condense on the external surfaces of the evaporator, transforming into water. The low-pressure gas then flows to valves HPV2 and SV2. From SV2, the coolant returns to the compressor, and the cycle repeats.

Upon triggering conditions, the controller stops the compressor and switches the valve positions to initiate the reverse cycle. Reverse cycle operations: CEU1 functions as an evaporator, and CEU2 as a condenser. Valve positions are as follows: HPV1 is closed; HPV2 is open; SV1 is open due to low pipeline pressure; and SV2 is closed due to high pipeline pressure.

The compressor pressurizes the gaseous coolant in the discharge line, directing it through valves HPV1 and HPV2. From HPV2, the coolant enters CEU2, releasing heat into the environment. The cooled coolant condenses and passes through the Metering Unit to CEU1, where it evaporates into low-pressure gas, absorbing heat from the environment. This process leads to the deposition of atmospheric moisture on the external surfaces of the evaporator, transforming into water. The low-pressure gas then flows to valves HPV1 and SV1. From SV1, the coolant returns to the compressor, and the cycle repeats.

Upon triggering conditions, the controller stops the compressor and changes the valve positions to revert to the direct cycle.

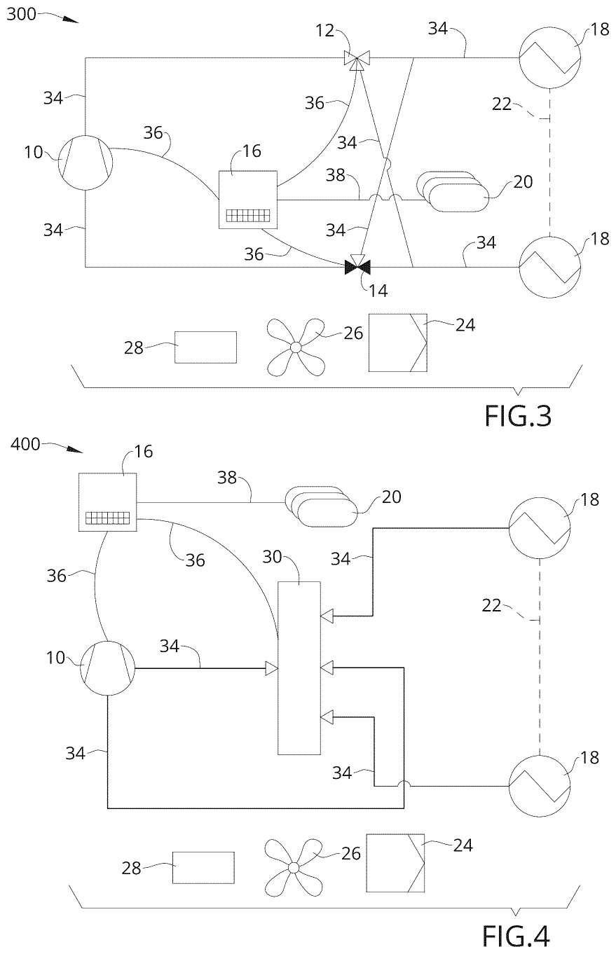

Referring to FIG. 3, a system based on three-way valves includes the following components:

Compressor 10 configured to pressurize a gaseous coolant within a discharge line. Condenser/Evaporator Units (CEU1, CEU2), wherein each unit functions as either a condenser or an evaporator depending on the direction of the cycle.

High-Pressure Valve (HPV), a three-way valve in the discharge line that directs the flow of the coolant to either CEU1 or CEU2 based on the cycle direction. A low-pressure valve (LPV), a three-way valve in the suction line that allows low-pressure coolant to flow towards the compressor, blocking high-pressure coolant from the opposite direction. An Operational Sensor Set (OSS) includes environmental sensors based on whose readings a decision to change the direction of the cycle can be made. Metering component 22 is disposed between the discharge and suction lines, for reducing the pressure of the coolant between these lines.

Controller 16 configured to decide the direction of the cycle based on sensor readings and/or timer inputs, and to control the operation of the compressor, the position of the valves, and peripheral service devices. An optional fan for directing air over the evaporator. Power supply 24 for providing energy to the system, with options for using renewable energy sources or electric grid power. Water tank and a distribution device for storing and distributing collected water for use.

Direct cycle operations: CEU1 functions as a condenser, and CEU2 as an evaporator. Valve positions are as follows: HPV is open towards CEU1, blocking the direction to CEU2; and LPV is open from the direction of CEU2, blocking the direction to CEU1.

The compressor pressurizes the gaseous coolant within the discharge line, directing it through HPV. From HPV, the coolant enters CEU1, releasing heat into the environment. The cooled coolant condenses and passes through the Metering component to CEU2, where it evaporates into low-pressure gas, absorbing heat from the environment. This process causes atmospheric moisture to deposit on the external surfaces of the evaporator, transforming into water. The low-pressure gas then flows to LPV. From LPV, the coolant returns to the compressor, and the cycle repeats.

Upon triggering conditions, the controller stops the compressor and switches the valve positions to initiate the reverse cycle.

Reverse cycle operations: CEU1 functions as an evaporator, and CEU2 as a condenser. Valve positions are as follows: HPV is open towards CEU2, blocking the direction to CEU1; and LPV is open from the direction of CEU1, blocking the direction to CEU2.

The compressor pressurizes the gaseous coolant in the discharge line, directing it through HPV. From HPV, the coolant enters CEU2, releasing heat into the environment. The cooled coolant condenses and passes through the Metering Unit to CEU1, where it evaporates into low-pressure gas, absorbing heat from the environment. This process leads to the condensation of atmospheric moisture on the external surfaces of the evaporator, transforming into water. The low-pressure gas then flows to LPV. From LPV, the coolant returns to the compressor, and the cycle repeats.

Upon triggering conditions, the controller stops the compressor and changes the valve positions to revert to the direct cycle.

Referring to FIG. 4, a reversible valve-based system includes the following components: compressor configured to pressurize a gaseous coolant within a discharge line. Condenser/Evaporator Units (CEU1, CEU2), wherein each unit functions as either a condenser or an evaporator depending on the direction of the cycle. Reversible valve (RV) 30 configured to alter the flow direction of a coolant; sensors 20 comprising environmental sensors based on whose readings a decision to change the direction of the cycle can be made. Metering component 22 may be disposed between the discharge and suction lines, for reducing the pressure of the coolant between these lines.

Controller 16 configured to decide the direction of the cycle based on sensor readings and/or timer inputs, and to control the operation of the compressor, the position of the valves, and peripheral service devices. An optional fan for directing air over the evaporator. Power supply for providing energy to the system, with options for using renewable energy sources or electric grid power. Water tank and a distribution device for storing and distributing collected water for use. Direct cycle operations: CEU1 functions as a condenser, and CEU2 as an evaporator.

Valve positions are as follows: The RV directs the flow of high-pressure coolants to CEU1 and receives low-pressure coolants from CEU2. The compressor generates pressurized gaseous coolant in the compression line, which is directed through pipes to RV. From RV, the coolant flows to CEU1, where it releases heat to the environment. Due to cooling, the coolant condenses and passes through the metering component 22 into CEU2, where it evaporates into low-pressure gas, extracting heat from the surroundings. This process causes atmospheric moisture to condense on the external surfaces of the evaporator, transforming into water. The low-pressure gas then flows back to RV, from where it is recycled into the compressor, repeating the cycle.

Upon conditions for switching, the controller stops the compressor and reverses the valve positions for a reverse cycle. Reverse cycle operations: CEU1 functions as an evaporator, and CEU2 functions as a condenser. Valve positions are as follows: The RV directs the flow of high-pressure coolants to CEU2 and receives low-pressure coolants from CEU1. The compressor generates pressure in a gaseous coolant within a delivery line, wherein said coolant is conveyed through pipelines to a valve RV. From the valve RV, the coolant enters CEU2 and dissipates heat into the ambient environment. Due to cooling, the coolant condenses and through a metering component 22 enters CEU1, where it evaporates into a low-pressure gas. During the evaporation process, the coolant absorbs heat from the surrounding environment, causing atmospheric moisture to deposit on the associated external surfaces of the evaporator, subsequently transitioning into water in its solid phase. The coolant, now as a low-pressure gas, proceeds to the valve RV. From the valve RV, the coolant is directed back into the compressor and the cycle repeats.

Referring to FIG. 5, a dual-arrangement system based on two compressors and characterized by two independent cooling dual-purpose heat exchangers operating alternately includes the following. A condenser of the first dual-purpose heat exchanger integrally combined with an evaporator of the second dual-purpose heat exchanger within a single heat exchange unit, and vice versa, the condenser of the second dual-purpose heat exchanger combined with the evaporator of the first dual-purpose heat exchanger.

The system may include the following components: compressors 10 for each dual-purpose heat exchanger, which may be a “combined” condenser/evaporator dual-purpose heat exchanger 19, designated as CCEU1 and CCEU2, where the evaporator of the first dual-purpose heat exchanger serves as the condenser of the second dual-purpose heat exchanger, and the evaporator of the second dual-purpose heat exchanger serves as the condenser of the first dual-purpose heat exchanger; an operational sensors set including environmental sensors, the readings of which are utilized to determine the need for changing the cycle direction; metering units positioned to reduce pressure between the compressor output and suction lines; controller configured to decide the direction of the cycle based on sensor readings and/or timing, controlling power to the compressors, valve positions, and peripheral service devices; an optional fan for directing air onto the evaporator; power supply for delivering energy to the system, capable of utilizing various sources including renewable energy or electrical grid power; water tank and a distribution device for storing and distributing collected water for consumption.

Dual purpose heat exchanger 18 may contains only one line inside which may be high to low pressure, which depends of cycle direction, while the “combined” condenser/evaporator dual-purpose heat exchanger 19 may contain two lines, where one is always the high line for the condenser phase for compressor 1 and the other line is dedicated to the evaporator for compressor 2. When compressor 1 is operating, compressor 2 is off. Combined dual-purpose heat exchanger 19 may serve unidirectional where after the refrigerant cycle direction changed, the compressor 1 is off and compressor 2 is on, and then combined dual-purpose heat exchanger 19 changes its role, with the idea being to avoid valves systems and thus increase reliability.

Direct cycle operations include a first compressor operational while a second compressor is idle. Compressors create pressurized gaseous coolant in the compression line, which flows through pipes to CCEU1 and releases heat to the environment. The cooled coolant condenses and passes through the metering unit to CCEU2, where it evaporates into low-pressure gas, extracting heat from the surroundings. This process leads to the condensation of atmospheric moisture on the external surfaces of the evaporator, transforming into water. The low-pressure gas then returns to the first compressor and the cycle repeats.

Upon the switching, the controller stops the first compressor and activates the second compressor. Reverse cycle operations: the second compressor operates while the first compressor remains idle.

The second compressor creates pressurized gaseous coolant in the compression line, which flows through pipes to CCEU2 and releases heat to the environment. The cooled coolant condenses and passes through a second metering component 22 to CCEU1, where it evaporates into low-pressure gas, extracting heat from the surroundings. This process leads to the condensation of atmospheric moisture on the external surfaces of the evaporator, transforming into water. The low-pressure gas then returns to the first compressor and the cycle repeats. Upon switching conditions, the controller stops the second compressor and reactivates the first compressor.

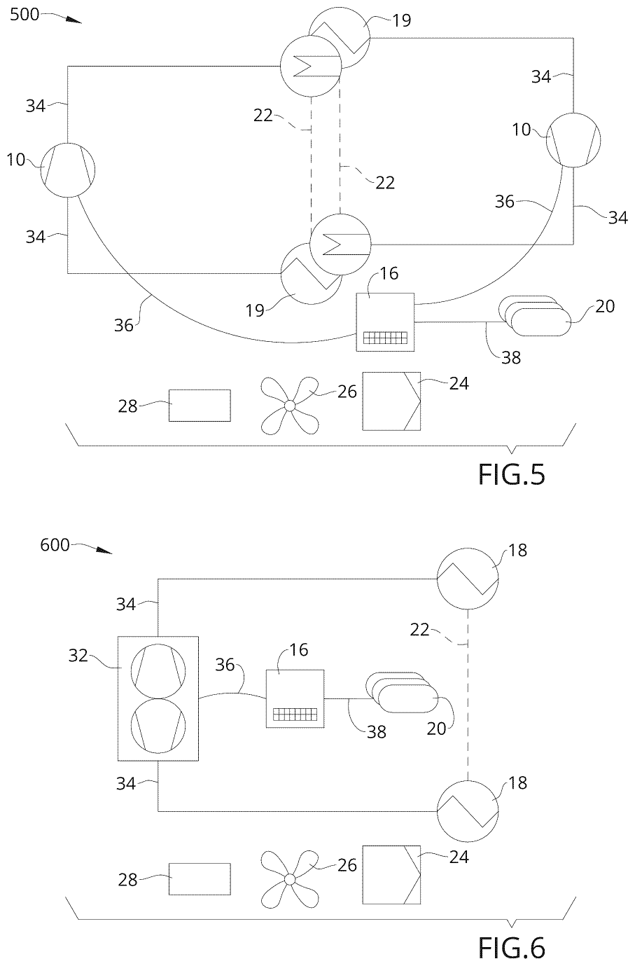

Referring to FIG. 6, a system based on a bidirectional compressor IS characterized by a first compressor capable of reversing the flow of coolant by switching the discharge and suction lines.

The system may include a bidirectional compressor 32 configured to alternate the direction of coolant flow. Condenser/evaporator units, designated as CEU1 and CEU2, wherein based on the cycle direction, each unit can function either in condenser mode or in evaporator mode.

An operational sensor including environmental sensors, the readings of which are utilized to determine the need for changing the cycle direction. Metering component 22 may be positioned to reduce pressure between the discharge and suction lines of the compressor. Controller configured to decide the direction of the cycle based on sensor readings and/or timing, controlling power to the compressor, position of the valves, and peripheral service devices. An optional fan for directing air onto the evaporator.

A power supply unit for delivering energy to the system, capable of utilizing various sources including renewable energy or electrical grid power. A water tank and a distribution device for storing and distributing collected water for consumption.

Direct cycle operations: the compressor operates to pump coolant into CEU1, which functions as a condenser. The coolant releases heat to the environment through CEU1, cools and condenses, and then passes through the metering component 22 into CEU2, where it evaporates into low-pressure gas, extracting heat from the surroundings. This process causes atmospheric moisture to deposits on the external surfaces of the evaporator, transforming into water. The low-pressure gas then returns to the compressor and the cycle repeats.

Upon the onset of switching conditions, the controller stops the compressor and restarts it in the reverse direction. Reverse cycle operations include the following the compressor operates to pump coolant into CEU1, which functions as a condenser. The coolant releases heat to the environment through CEU1, cools and condenses, and then passes through the metering component 22 into CEU2, where it evaporates into low-pressure gas, extracting heat from the surroundings. This process causes atmospheric moisture to deposit on the external surfaces of the evaporator, transforming into water. The low-pressure gas then returns to the compressor and the cycle repeats. Upon the onset of further switching conditions, the controller stops the compressor and restarts it for operation in the original direction.

A method of making the subject disclosure requires production of an evaporator component and attaching it, via a valve system line, to a compressor, wherein the valve system is operatively associated with a controller and sensors. Then fill the system with coolant, attach a fan 26 for forcing air circulation, and build up the storage to collect water. Optional elements may include a storage unit where water may be delivered to a customer directly, and a distribution system, where water may be stored. Forced Air circulation may improve the performance, but the subject disclosure can work without it. Some embodiments include a filtering device, while others do not (agricultural for example).

In some embodiments, the subject disclosure includes a system having two position valves and stop valves 13. In some embodiments, the system may be based on 3-way valves and/or eversible valves. The subject disclosure may include a dual arrangement based on two compressors or a bi-directional compressor.

The subject disclosure may be installed in the household and adapted to collect water for further use, or the system may be installed in an agricultural area to water crops, or anywhere where water is needed. The subject disclosure could also be used for efficient air drying.

Additional systemic components may include coolant, a distribution device, an evaporator, a filtering device, a forced-air circulation device, a set of essential components, a storage unit, and a valve system.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A system for converting water vapor to liquid water, the system comprising: a first dual-purpose heat exchanger and a second dual-purpose heat exchanger arranged in a fluid coupling in such a way as to enable a reversible refrigeration cycle of the first and second dual-purpose heat exchangers so that while the first dual-purpose heat exchanger, in a cooling condition, cools a first surface associated thereto, the second dual-purpose heat exchanger, in a heating condition, heats a second surface associated thereto.

2. The system of claim 1, where, in operation, a first ambient water vapor deposits frozen water on the first surface when the first surface reaches a sub-freezing temperature while deposited frozen water on the second surface melts for collection after the second surface reaches an above-freezing temperature.

3. The system of claim 1, wherein a controller is operatively associated with the system so that the reversible refrigeration cycle is selectively activated, whereby when the first dual-purpose heat exchanger switches from the cooling condition to the heating condition, the second dual-purpose heat exchanger switches from the heating condition to the cooling condition.

4. The system of claim 3, wherein the reversible refrigeration cycle is enabled by a refrigerant coursing through the fluid coupling.

5. The system of claim 4, each dual-purpose heat exchanger comprises an evaporator component and a condenser component for changing a temperature of their respective associated surface.

6. The system of claim 5, wherein a compressor is operatively associated with the system for pressurizing the refrigerant into a gaseous state for entering the condenser of the first or second dual-purpose heat exchanger that is in the respective heating condition.

7. The system of claim 6, wherein a metering device is operatively associated with the system for dropping the pressurize of the refrigerant leaving the condenser of the first or second dual-purpose heat exchanger in the respective heating condition, wherein the metering device liquifies said refrigerant for entering the evaporator of the first or second dual-purpose heat exchangers in the respective cooling condition.

8. The system of claim 7, wherein valves are operatively associated with the fluid coupling to effectuate the reversible refrigeration cycle.

9. The system of claim 8, wherein the controller is programmable to activate the reversible refrigeration cycle when one or more predetermined thresholds are met.

10. The system of claim 9, wherein one or more sensors are operatively associated with the system determining when the one or more predetermined thresholds are met.
